(19) United States
(12) Patent Application Publication
(10) Pub. No.: US 2003/0213603 A1
(43) Pub. Date: Nov. 20, 2003

(54) Dual use extension apparatus for a tool

(76) Inventor: David B. Fisher, Bowling Green, KY (US)

Correspondence Address: Ronald A. Sandler, Jones, Day, Reavis & Pogue, 77 West Wacker Drive, Chicago, IL, 60540, US

(21) Appl. No.: 10/145,255

(22) Filed: May 14, 2002

(51) Int. Cl. B27C 3/08

(52) U.S. Cl. 173/170

(57) ABSTRACT

An extension apparatus is disclosed as is a combination of an extension apparatus and a tool. The extension apparatus is an elongated pole having an extended end portion and a near end portion and a trigger located intermediate of the two end portions. The tool, in the form of a hedge trimmer, is attached to the extended end portion or alternatively may be made integral. Other tools may be used either integral with the extension apparatus or detachable and the extension apparatus itself may be extendable. An operator can use the combination to work at a distance, such as tree branch trimming, or close-in, such as cutting logs. This is easily accomplished by having the operator's primary hand at the trigger and the operator's secondary hand either at the near end portion of the pole or at the extended end portion depending upon whether the work is at a distance or nearby.

### BACKGROUND OF THE INVENTION

1. Field of the Invention

The present invention relates to an extension apparatus and more particularly to an extension apparatus for a tool that can be used to place the tool at a far distance from an operator and yet still allow the operator to move the tool near him for close-in work, the extension apparatus being simply constructed, easy to use and reliable in operation.

2. Description of the Related Art

Extension poles for tools are well known. For example, U.S. Pat. No. 5,493,758 discloses a manually operated tree pruner. U.S. Pat. No. 4,515,423 discloses an extension device for electrically powered tools, such as a hedge trimmer. In both cases, an operator's primary hand, the hand that either operates the tree pruner or presses the trigger switch, is placed at the far end of an extension pole, the end that is opposite from the end of the pole attached to the tool. Both patents disclose that the operator's secondary hand, the hand that supports and guides the pole, is placed between the two ends of the pole. In particular, the U.S. Pat. No. 4,515,423 shows an intermediately located handle for the user's secondary hand.

A major problem with the devices described above is that for close-in work the operator cannot easily use the tool while it is attached to the end of the extension pole because one of the operator's hands must remain at or near the end of the pole opposite the end with the tool. When the tool is elevated for distant work, the force vectors of the weight of the tool are such that the moment arm created by the pole/tool combination is not very large. However, for close-in work, where the pole/tool combination is disposed generally horizontal to the ground, the moment arm is quite large making it extremely difficult to support and guide the tool. Thus, for close-in work, the tool must be removed from the extension pole or another tool not connected to an extension pole must be used.

### BRIEF SUMMARY OF THE INVENTION

The difficulties encountered by previous devices have been overcome by the present invention. What is described here is a dual use extension apparatus for a tool comprising an elongated pole having an extended end portion and a near end portion, the extended end portion being adapted to connect to a tool, an actuator connected to the pole between the extended end portion and the near end portion, and means connected to the pole and to the actuator for causing the tool to operate.

There are a number of advantages, features and objects achieved with the present invention which are believed not to be available in earlier related devices. For example, one advantage is that the present invention provides an extension apparatus that can be used both for work at a distance from the operator as well as for close-in work without any need to remove the tool from the extension apparatus. Another object of the present invention is to provide an extension apparatus which is simply constructed, easy to use and reliable in operation. A further advantage of the present invention is to provide an extension apparatus which accommodates the natural spacing of an operator's hands so that there is minimal bending or stooping required when the extension apparatus and tool combination is used for close in or near work. Another feature of the present invention is to provide a versatile extension apparatus which may be detachable from the tool or which may be integrated with the tool and which may be a fixed length or adjustable in length.

A more complete understanding of the present invention and other objects, advantages and features thereof will be gained from a consideration of the following description of two preferred embodiments read in conjunction with the accompanying drawing provided herein. The embodiment represents examples of the invention which are described here in compliance with Title 35 U.S.C. section 112 (first paragraph), but the invention itself is defined by the attached claims.

### BRIEF DESCRIPTION OF THE SEVERAL VIEWS OF THE DRAWING

FIG. 1 is an isometric view of an extension apparatus connected to an electrically powered tool in the form of a hedge trimmer.

FIG. 2 is an enlarged elevation view of a portion of the extension apparatus showing an actuator.

FIG. 3 is an elevation view of a portion of another embodiment of the extension apparatus having a cord extending through an end of the apparatus.

FIG. 4 is a sectional elevation view of a portion of the extension apparatus showing a coiled electrical cord within an elongated pole.

FIG. 5 is an enlarged sectional elevation view of a portion of the extension apparatus showing an internal electrical cord.

FIG. 6 is a schematic view of an operator using an extension apparatus and tool combination for distant work.

FIG. 7 is a schematic view of an operator using the extension apparatus and tool combination for close-in work.

### DETAILED DESCRIPTION OF PREFERRED EMBODIMENTS OF THE INVENTION

While the present invention is open to various modifications and alternative constructions, the preferred embodiments shown in the drawing will be described herein in detail. It is understood, however, that there is no intention to limit the invention to the particular embodiments, forms or examples disclosed. On the contrary, the intention is to cover all modifications, equivalent structures and methods, and alternative constructions falling within the spirit and scope of the invention as expressed in the appended claims, pursuant to Title 35 U.S.C. section 112 (second paragraph).

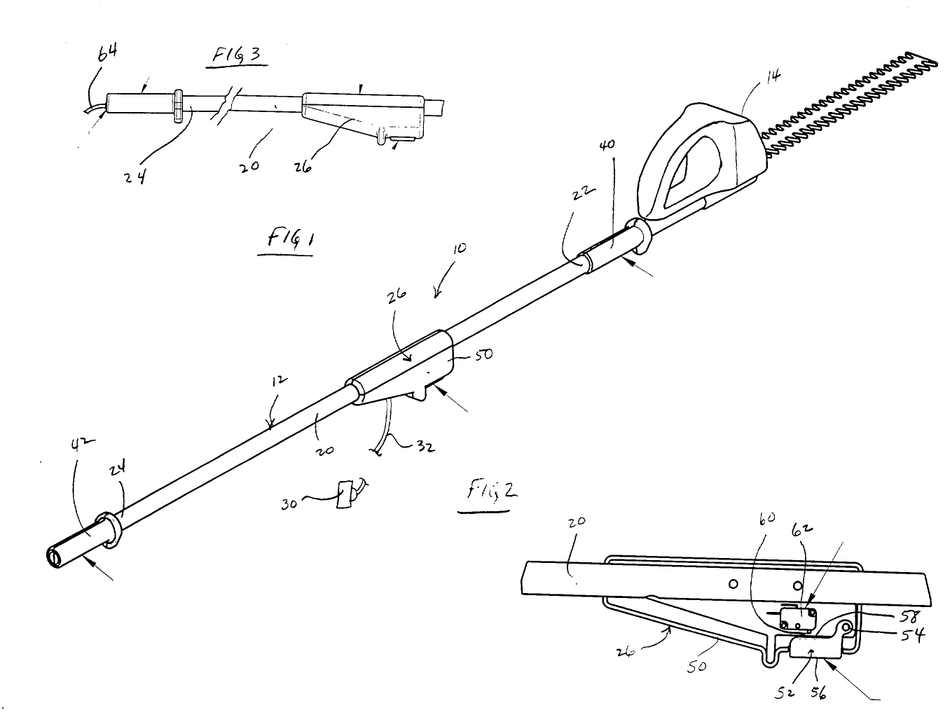

Referring now to FIG. 1, there is shown a combination 10 of an extension apparatus 12 and a tool 14. The tool 14 illustrated is an electrically powered hedge trimmer though it is understood that other tools may be used, powered or manually operated. Examples of powered tools include gas engine driven products and products powered by compressed gas or linear combustion motors.

The extension apparatus 12 includes a hollow elongated pole 20 having an extended end portion 22 and an opposite or near end portion 24. Between or intermediate the extended end portion and the near end portion is an actuator device 26. As will be explained, the actuator includes a supporting structure, a trigger and a switch for connecting the tool 14 with a power source which may be in the form of an electrical outlet 30 by way of an electrical cord 32.

Also shown in FIG. 1 is an extended hand holding grip 40 mounted to the extended end portion 22 of the elongated pole. A similar hand holding grip 42 is mounted to the near end portion 24 of the elongated pole.

Referring now to FIG. 2, the actuator 26 is shown in more detail and includes a housing 50 mounted to the elongated pole and enclosing a trigger 52 which is pivoted around a mounting shaft 54. The trigger has a lower or outer surface 56 for contact with an operator's finger, and an upper or inner surface 58 which makes contact with a spring biased plunger 60 of an electrical switch 62, the switch being mounted within the housing. The electrical cord 32, FIG. 1, is shown attached to the housing 50 or an electrical cord 64, FIG. 3, may be inserted as the near end portion 24 of the pole 20.

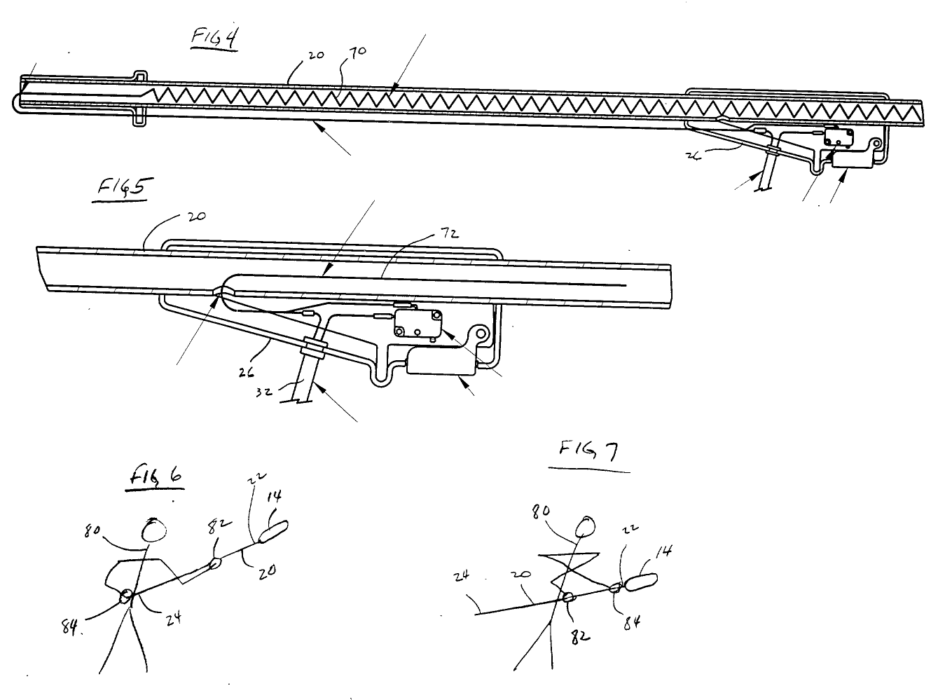

Referring now to FIGS. 4 and 5, section views are provided to show two alternative methods of connecting the tool to the switch by electrical wires. For example, in FIG. 4 an electrical wire 70 is placed within the hollow elongated pole 20 and may be coiled so that the pole may have a telescoping extension portion (not shown) or other type of extension device to allow placement of the tool 14 even further away from the actuator 26 than is shown in FIG. 1.

Illustrated in FIG. 5 is a straight electrical wire 72 within the pole 20 which may be used, for example, when the tool is fixed to or integral with the elongated pole and the pole does not have any extensions. FIGS. 4 and 5 illustrate the versatility of the extension apparatus. The extension apparatus may be fixed to a tool or the tool may be detachable from the extension apparatus and in either case, the extension apparatus may include an extending piece for lengthening the extension apparatus itself.

Referring now to FIGS. 6 and 7, the versatility and operation of the extension apparatus is illustrated further. Generally a user of any tool has a primary hand and a secondary hand. This means that a right handed person is likely to use his right hand as the primary hand for operating an actuator such as the trigger 52, FIG. 2, when operating a tool. The operator's other hand, referred to here as the secondary hand, is generally used to support or help manipulate the tool. For a right handed person, the secondary hand is the left hand. It has also been recognized that operators have a natural spacing between their hands when handling a pole-like device and the spacing is a function of whether the work is at a distance from the operator or whether the work is relatively close to the operator. For example, in FIG. 6, an operator 80 grips the pole 20 as shown when there is an intention to extend the tool 14 away at a distance from the operator. The operator's primary or right hand 82 is shown gripping the elongated pole intermediate the length of the pole. This is at the location of the actuator. The operator's secondary or left hand 84 is shown gripping the pole at the near end portion. In this position, the pole may extend across the front-left side of the operator and is used for a long reach.

Referring now to FIG. 7, when the operator is doing close in or nearby work, the right hand 82 is still holding the actuator at an intermediate position on the pole whereas the left or secondary hand 84 has been shifted to the extended end portion of the pole so as to be closer to the tool. In this fashion the tool is brought much closer to the operator and the pole may extend across the front-right side of the operator. It is also noted that that portion of the pole extending away from the operator's right hand in a direction away from the tool, namely, the length of pole between the actuator 26 and the near end portion 24 acts as a counter-weight for the tool 14. In this way, the operator will have greater control of the tool and the moment arm created is greatly decreased.

The natural spacing between an operator's primary and secondary hands is shown by FIGS. 6 and 7. This makes working with the extension apparatus and tool combination easier, less fatiguing and with greater control. The natural spacing will, of course, vary somewhat from person to person, however, generally the actuator is located roughly at a distance twice as far from the near end portion as from the extended end portion. With slightly more precision a good distance between the actuator and the near end portion compared to the distance between the actuator and the extended end portion is the ratio of about 16 to 9.

The operator of the device shown in FIG. 1 of U.S. Pat. No. 4,515,423 cannot operate the hedge trimmer in a manner like that shown in applicant's FIG. 7 because the operator's primary hand, the right hand, is located near the near end portion of the pole because the trigger for the trimmer device is located at the end of the pole closest to the operator.

In the present invention the actuator 26 is located intermediate the end portions 22, 24 of the pole and alternative hand holding regions represented by the grips 40, 42 are provided as a function of whether extended work or nearby work is to be done. Moving the secondary hand from one hand holding region to the other is simple and quickly accomplished and there is no need to detach the tool from the pole nor is there a requirement for another tool with a short handle for close-in work to be available. It is also noted that the electrical wire from the actuator to the tool may be routed internally as shown in FIG. 5 or partially internally and partially externally as shown in FIG. 4.

By way of operating examples, when the tool is a chain saw, the same extension apparatus and tool may be used to trim or cut elevated tree branches on the one hand and on the other to cut felled logs without requiring the operator to excessively bend or stoop. The same may be said if the tool is a hedge trimmer. The same combination may be used to trim tall shrubs and bushes and also to trim shorter shrubs and bushes without requiring the operator to bend or stoop.

The above specification describes in detail two preferred embodiments of the present invention. Other examples, embodiments, modifications and variations will, under both the literal claim language and the doctrine of equivalents, come within the scope of the invention defined by the appended claims. For example, as stated, the extension pole may be fixed to a tool or detachable and the pole itself may have a telescoping extension piece. Also the pole may be solid or hollow and any one of many different types of tools may be attached or made integral with the pole. Furthermore, an electrical cord may be connected at the near end of the pole or at the actuator device. Also, the pole may have hand grips or not; a contrasting color may be used to indicate hand holding regions or no special indicia may be used at all, there being instructions as to hand placements as a function of the distance of the work from the operator. These are all considered equivalent structures and will also come within the literal language of the claims. Furthermore, different spacings between the actuator and the end portions may be used and are considered equivalent to that disclosed here. In addition, if a gas engine driven tool is used, a throttle control may be used in place of the trigger 52 and the electrical switch 62. If a compressed gas driven tool is used, the actuator device may be a valve switch, and if a linear combustion motor is used, an electrical trigger may be used for the actuator device. Still other alternatives will also be equivalent as will many new technologies. There is no desire or intention here to limit in any way the application of the doctrine of equivalents nor to limit or restrict the scope of the invention.

1. A dual use extension apparatus for a tool comprising:
an elongated pole having an extended end portion and a near end portion;
said extended end portion being adapted to connect to a tool;
an actuator connected to said pole between said extended end portion and said near end portion; and
means connected to said pole and to said actuator for causing said tool to operate wherein for extended distant work an operator places one hand to operate the actuator and another hand at or near said near end portion of said pole and for nearby work said operator places said one hand to operate the actuator and said other hand at or near said extended end portion of said pole.

2. An apparatus as claimed in claim 1 wherein:
said actuator is connected to said elongated pole closer to said extended end portion than to said near end portion.

3. An apparatus as claimed in claim 2 wherein:
said actuator is connected to said elongated pole at a distance roughly twice as far from said near end portion as from said extended end portion.

4. An apparatus as claimed in claim 1 wherein:
said near end portion of said pole includes a first hand holding region; and
said extended end portion of said pole includes a second hand holding region.

5. An apparatus as claimed in claim 4 wherein:
said first and said second hand holding regions include hand grips.

6. An apparatus as claimed in claim 1 wherein:
said tool operating means is an electrical wire.

7. An apparatus as claimed in claim 2 wherein:
said near end portion of said pole includes a first hand holding region; and
said extended portion of said pole includes a second hand holding region.

8. An apparatus as claimed in claim 7 wherein:
said actuator is connected to said pole at a location roughly twice the distance from said near end portion as from said extended end portion.

9. An apparatus as claimed in claim 8 wherein:
said tool operating means is an electrical wire.

10. An apparatus as claimed in claim 9 wherein:
said first and said second hand holding regions include hand grips.

11. A dual use extension apparatus and tool combination comprising:
an elongated pole having a first end portion and a second end portion;
a tool connected to said first end portion;
an actuator connected to said pole intermediate said first end portion and said second end portion; and
means connected to said pole, to said actuator and to said tool for causing said tool to operate.

12. An apparatus as claimed in claim 11 wherein:
said actuator is connected to said elongated pole closer to said tool than to said second end portion of said elongated pole.

13. An apparatus as claimed in claim 12 wherein:
said actuator is connected to said pole at a location about twice the distance from said second end portion as from said first end portion.

14. An apparatus as claimed in claim 11 wherein:
said second end portion of said pole includes a first hand holding region; and
said first end portion of said pole includes a second hand holding region.

15. An apparatus as claimed in claim 14 wherein:
said first hand holding region, said second hand holding region and said actuator are spaced along said pole to naturally accommodate an operator.
